(19) United States
(12) Patent Application Publication
(10) Pub. No.: US 2012/0153105 A1
(43) Pub. Date: Jun. 21, 2012

(54) BRACKET ASSEMBLY

(76) Inventor: John Joseph Kelley, II, Spring, TX (US)

(21) Appl. No.: 13/236,399

(22) Filed: Sep. 19, 2011

Related U.S. Application Data
(60) Provisional application No. 61/383,958, filed on Sep. 17, 2010.

(51) Int. Cl. F16M 13/02; B23P 11/02; B23P 11/00

(52) U.S. Cl. 248/219.4; 248/220.31; 29/428; 29/453

(57) ABSTRACT

Described are bracket assemblies having a bracket, a first insert, and a second insert, each insert including a mating surface. At least one lateral aperture is formed when the mating surfaces of the first insert and the second insert are coupled to each other and is configured to at least partially enclose a lateral portion of a fence structure. A plurality of longitudinal apertures are formed when the mating surfaces of the first insert and the second insert are coupled to each other and are configured to at least partially enclose a longitudinal portion of the fence structure.

### CROSS REFERENCE TO RELATED APPLICATION

This invention claims the benefit of U.S. Provisional Application Ser. No. 61/383,958, entitled “Bracket for Rail Assembly,” filed Sep. 17, 2010, the entire contents of which are incorporated herein by this reference.

### FIELD OF THE INVENTION

This invention relates generally to the field of brackets, and more specifically to brackets used to secure fence structures to fence posts.

### BACKGROUND

Fences generally include a series of posts secured in a surface and fence structure, which runs between the posts. Typically, fence posts are first installed on a surface such as the ground or a foundation. After the fence posts are secured in or to the surface, the fence structure is positioned and held against the posts in order to secure the fence structure to the posts. Fence structures can be panels, chain-link fencing, or wire mesh fencing, among others. Often, a bracket or fastener, such as a staple, is used to secure the fence structure to the posts.

One problem when fastening the fence structure between fence posts is aligning a particular structural member of the fence structure between the posts. The fence posts are not always exactly vertical or positioned in a straight line or at right angles with respect to each other. Moreover, the fence posts are not always evenly spaced apart from each other. Other factors, such as varying grades over which the fence is being erected, contribute to problems with alignment.

When fastening the fence structure (e.g., wire) to the posts, fence installers must compensate for the misalignment. Sometimes, such compensation results in the fence structure fitting loosely between posts, or the fence structure being overly stretched between posts. Such variation can harm the strength and function of the fence as well as compromise its aesthetic value.

To overcome such variations, fence installers often adjust the positioning of the misaligned poles. Such repositioning is costly in terms of time, labor and efficiency. Further, some misalignment is caused by varying terrain, and cannot feasibly be remedied.

A less laborious solution is to utilize a fastener, such as a nail, screw, or conventional bracket to secure the fence structure to the post. However, nails or screws alone are inadequate devices for permanently fastening the fence structures to the posts. Moreover, existing fence brackets generally do not adjust for misalignment in the posts, particularly those caused by varying terrain.

Therefore, there is a need for an apparatus that will assist a fence installer with fastening and aligning fence structures to a pole in a consistent, non-laborious and inexpensive manner.

### SUMMARY

Certain embodiments of the present invention include a bracket assembly having a bracket, a first insert, and a second insert, wherein each insert includes a mating surface. The first insert and the second insert may be releasably coupled to each other via a snap-fit coupling. The first insert and the second insert may also be pivotally coupled or slidingly coupled to the bracket. In some embodiments, the bracket is configured to couple to a fence post.

At least one lateral aperture may be formed when the mating surfaces of the first insert and the second insert are coupled to each other, wherein the at least one lateral aperture is configured to at least partially enclose a lateral portion of a fence structure. In some embodiments, the at least one lateral aperture comprises a first lateral aperture and a second lateral aperture.

A plurality of longitudinal apertures may also be formed when the mating surfaces of the first insert and the second insert are coupled to each other, wherein the longitudinal apertures are configured to at least partially enclose a longitudinal portion of the fence structure. The plurality of longitudinal apertures may comprise a first longitudinal aperture and a second longitudinal aperture. In other embodiments, the plurality of longitudinal apertures comprise a first longitudinal aperture and a plurality of second longitudinal apertures, wherein the first longitudinal aperture is spaced apart from the plurality of second longitudinal apertures. In these embodiments, the first longitudinal aperture and one of the plurality of second longitudinal apertures are configured to at least partially enclose the longitudinal portion of the fence structure.

### BRIEF DESCRIPTION OF THE DRAWINGS

FIG. 1 is an exploded perspective view of two bracket inserts according to one embodiment of the present invention.

FIG. 2 is a top exploded view of the bracket inserts of FIG. 1.

FIG. 3 is a front exploded view of the bracket inserts of FIG. 1.

FIG. 4 is a side exploded view of the bracket inserts of FIG. 1.

FIG. 5 is a back exploded view of the bracket inserts of FIG. 1.

FIG. 6 is an partially exploded perspective view of the bracket inserts of FIG. 1 and a bracket.

FIG. 7 is a perspective view of the bracket inserts and the bracket of FIG. 6.

FIG. 8 is an exploded perspective view of two bracket inserts according to another embodiment of the present invention.

### DETAILED DESCRIPTION

Certain embodiments of the invention provide bracket assemblies for coupling object in a versatile manner. While the bracket assemblies are discussed for use with fence structures, they are by no means so limited. Rather, embodiments of the bracket assemblies may be used to couple any type of suitable structure or otherwise as desired.

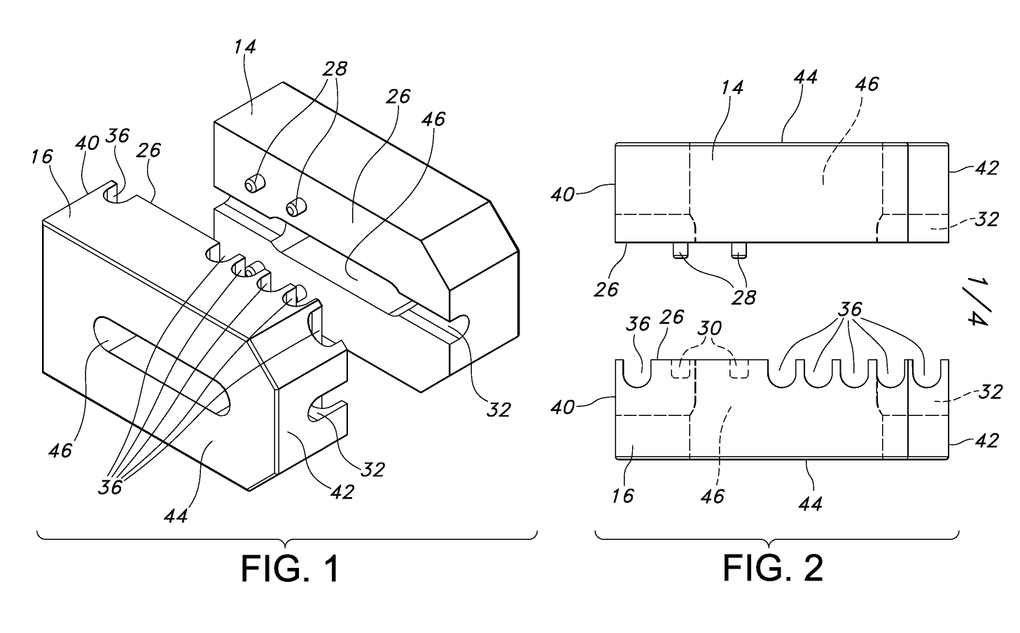

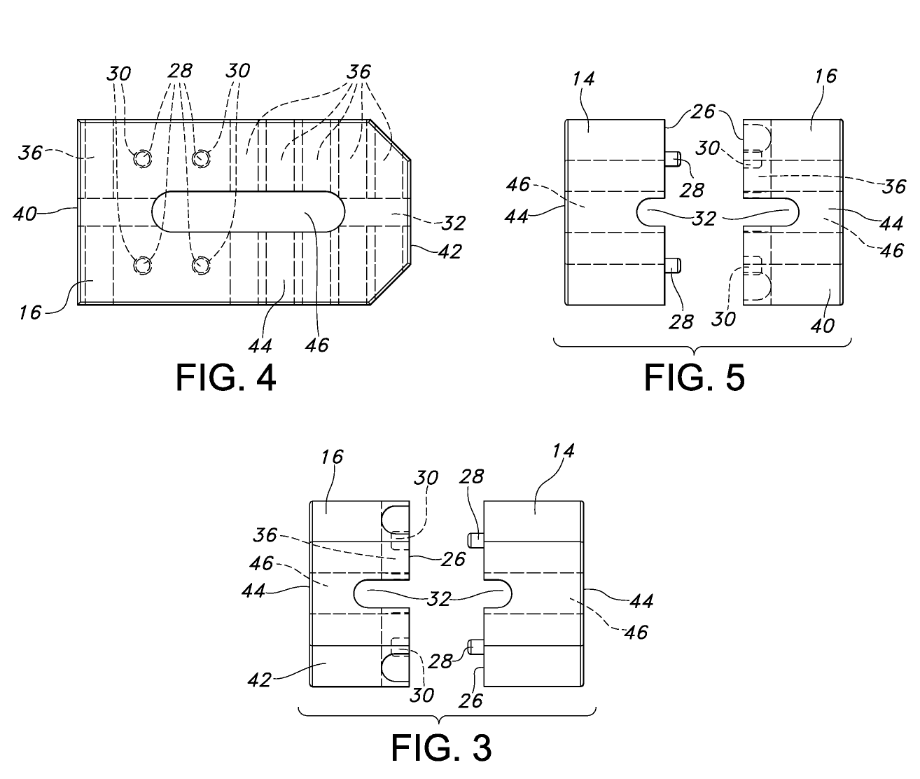

FIGS. 1-8 illustrate various embodiments of a bracket assembly 10. In these embodiments, the bracket assembly 10 comprises a bracket 12 and two bracket inserts 14, 16. The bracket 12 and the bracket inserts 14, 16 may be formed of any suitable material including, but not limited to, plastic, aluminum, stainless steel, iron, composite material, or other suitable material.

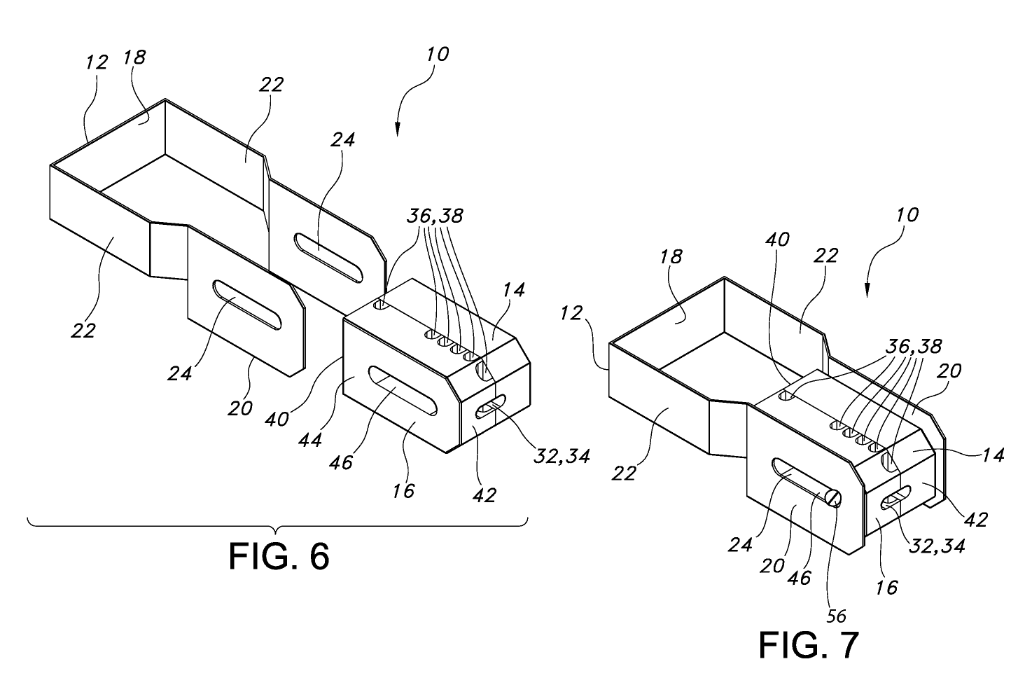

In some embodiments, the bracket 12 comprises a base 18 and a pair of arms 20. The arms 20 are coupled to the sides 22 of the base 18. In some embodiments, each arm 20 comprises an insert attachment slot 24. In some embodiments, the base 18 is configured to couple to a fence post. However, one of skill in the relevant art will understand that the bracket 12 is not so limited and may be secured to any suitable structure including but not limited to a fence post, building, pole, tree, or other suitable natural or man-made structure. A fastening device (not shown) may be used to secure the base 18 to these types of structures. Suitable fastening devices include but are not limited to screws, bolts, rivets, pins, nails, or other similar mechanical fasteners. In some embodiments, the bracket 12 may be a banded bracket (as shown in FIGS. 6-7). In other embodiments, the bracket 12 may be a universal bracket, a swivel bracket, or other similar suitable brackets. A person of ordinary skill in the relevant art will understand that the bracket 12 may be any suitable bracket that provides a design that is configured to pivotally couple to the bracket inserts 14, 16 and couple to a suitable structure.

As shown in FIGS. 1-8, each bracket insert 14, 16 comprises a mating surface 26. The mating surfaces 26 are configured to form at least one lateral aperture 34 and a plurality of longitudinal apertures 38 when the mating surfaces 26 are in mating contact with each other, as illustrated in FIGS. 6-7.

In some embodiments, such as the embodiment shown in FIGS. 1-7, each lateral aperture 34 is formed via a lateral channel 32 that is positioned within each mating surface 26 so that the lateral channel 32 on one mating surface 26 is positioned substantially adjacent the lateral channel 32 on the opposing mating surface 26 to form the lateral aperture 34 when the two mating surfaces 26 are in mating contact with each other. In the embodiment shown in FIGS. 1-7, the lateral channel 32 of the bracket insert 14 has a shallower depth than the lateral channel 32 of the bracket insert 16, but any suitable configuration of the two lateral channels 32 is appropriate that results in the desired shape of the lateral aperture 34.

In other embodiments, each lateral aperture 34 may be formed by a single lateral channel 32 that is positioned within one of the mating surfaces 26 so that the lateral channel 32 is positioned adjacent a substantially non-recessed section of the opposing mating surface 26 when the two mating surfaces 26 are in mating contact with each other.

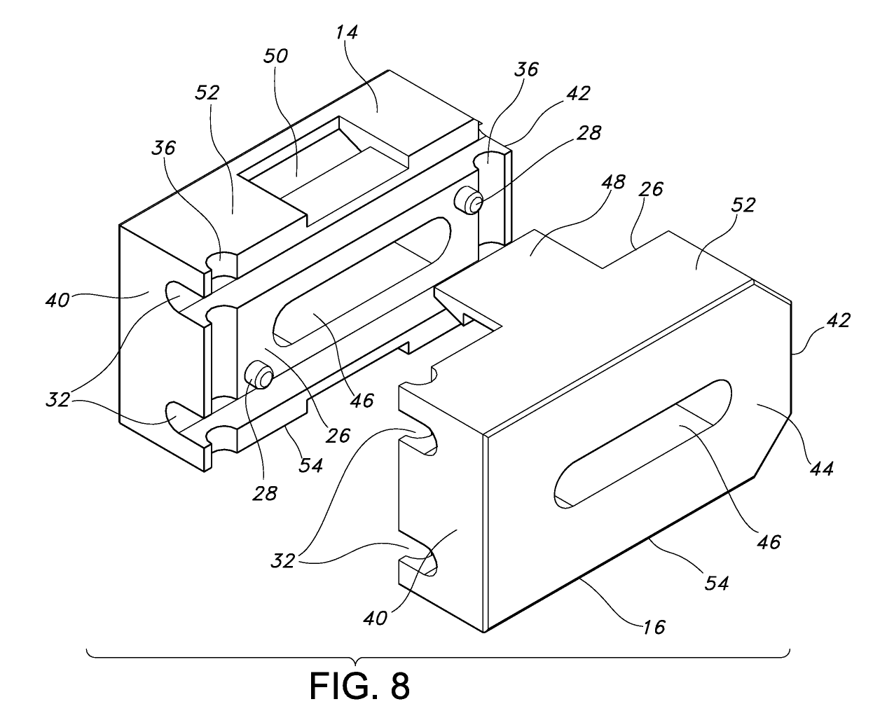

In yet other embodiments, such as the embodiment shown in FIG. 8, each mating surface 26 comprises two lateral channels 32 so that the lateral channels 32 on one mating surface 26 are positioned substantially adjacent the lateral channels 32 on the opposing mating surface 26 to form two lateral apertures 34 (not shown in FIG. 8) when the two mating surfaces 26 are in mating contact with each other.

In these embodiments, each lateral aperture 34 is configured to at least partially enclose a lateral portion of a fence structure. Each lateral aperture 34 may be shaped to accommodate the cross-sectional shape of the lateral portion of the fence structure, while also allowing some additional space for the lateral portion of the fence structure to move within the lateral aperture 34. In some embodiments, the lateral portion of the fence structure is a wire, however one of skill in the relevant art will understand that the lateral portion of the fence structure can be panels, chain-link fencing, wire mesh fencing, or other structures.

In some embodiments, such as the embodiment as shown in FIGS. 6 and 7, the lateral aperture 34 is centrally positioned within each mating surface 26 to provide a central coupling location for the lateral portion of the fence structure.

In other embodiments, such as the embodiment shown in FIG. 8, the two lateral channels 32 positioned proximate a first side 52 of each bracket insert 14, 16 are spaced apart from the two lateral channels 32 positioned proximate a second side 54 of each bracket insert 14, 16. When the two mating surfaces 26 are in mating contact with each other (similar to the coupled bracket inserts 14, 16 shown in FIGS. 6 and 7), the two lateral channels 32 proximate the first side 52 form a first lateral aperture 34 (a first lateral coupling location) and the two lateral channels 32 proximate the second side 54 form a second lateral aperture 34 (a second lateral coupling location). In these embodiments, the lateral portion of the fence structure is coupled to the two lateral coupling locations, where the spacing between the two lateral coupling locations substantially corresponds to the spacing of the lateral portion of the fence structure. One of skill in the relevant art will understand that any suitable number of lateral apertures 34 having any suitable configuration and spacing may be used to couple the bracket assembly 10 to the lateral portion of the fence structure.

In some embodiments, such as the embodiment shown in FIGS. 1-7, the longitudinal apertures 38 are formed via a plurality of longitudinal channels 36 that are positioned within one of the mating surfaces 26 so that the longitudinal channels 36 are positioned adjacent a substantially non-recessed section of the opposing mating surface 26 when the two mating surfaces 26 are in mating contact with each other.

In other embodiments, the longitudinal channels 36 are positioned within each mating surface 26 so that the longitudinal channels 36 on one mating surface 26 are positioned substantially adjacent the longitudinal channels 36 on the opposing mating surface 26 to form the longitudinal apertures 38 when the two mating surfaces 26 are in mating contact with each other.

In yet other embodiments, such as the embodiment shown in FIG. 8, each mating surface 26 comprises two longitudinal channels 36 so that the longitudinal channels 36 on one mating surface 26 are positioned substantially adjacent the longitudinal channels 36 on the opposing mating surface 26 to form two longitudinal apertures 38 (not shown in FIG. 8) when the two mating surfaces 26 are in mating contact with each other.

In these embodiments, each longitudinal aperture 38 is configured to at least partially enclose a longitudinal portion of the fence structure. Each longitudinal aperture 38 may be shaped to accommodate the cross-sectional shape of the longitudinal portion of the fence structure, while also allowing some additional space for the longitudinal portion of the fence structure to move within the longitudinal aperture 38. In some embodiments, the longitudinal portion of the fence structure is a wire, however one of skill in the relevant art will understand that the longitudinal portion of the fence structure can be panels, chain-link fencing, wire mesh fencing, or other structures.

In some embodiments, such as the embodiment shown in FIGS. 1-7, the longitudinal apertures 38 comprise a first longitudinal aperture 38 positioned proximate a first end 40 of the coupled bracket inserts 14, 16 (a first longitudinal coupling location) and spaced apart from a plurality of second longitudinal apertures 38 positioned proximate a second end 42 of the coupled bracket inserts 14, 16 (a plurality of second longitudinal coupling locations). Each one of the plurality of second longitudinal apertures 38 is positioned a different distance from the first longitudinal aperture 38 to provide a range of second longitudinal coupling locations relative to the first longitudinal coupling location. In other words, the plurality of second longitudinal apertures 38 are positioned in a row proximate the second end 42.

In these embodiments, the longitudinal portion of the fence structure is coupled to the first longitudinal aperture 38 (the first longitudinal coupling location) and to one of the plurality of second longitudinal apertures 38 (the second longitudinal coupling location). The spacing between the first longitudinal aperture 38 and the selected second longitudinal aperture 38 substantially corresponds to the spacing of the longitudinal portion of the fence structure. In these embodiments, the coupled bracket inserts 14, 16 may be configured to couple to a specific longitudinally-spaced fence structure or may be configured to couple to multiple styles of fence structures and multiple positions of wires within the particular style of fence structure.

In other embodiments, such as the embodiment shown in FIG. 8, the two longitudinal channels 36 positioned proximate the first end 40 of each bracket insert 14, 16 are spaced apart from the two longitudinal channels 36 positioned proximate the second end 42 of each bracket insert 14, 16. When the two mating surfaces 26 are in mating contact with each other (similar to the coupled bracket inserts 14, 16 shown in FIGS. 6 and 7), the two longitudinal channels 36 proximate the first end 40 form the first longitudinal aperture 38 (the first lateral coupling location) and the two lateral channels 36 proximate the second end 42 form the second longitudinal aperture 38 (the second longitudinal coupling location). In these embodiments, the longitudinal portion of the fence structure is coupled to the two longitudinal coupling locations, where the spacing between the two longitudinal coupling locations substantially corresponds to the spacing of the longitudinal portion of the fence structure. One of skill in the relevant art will understand that any suitable number of longitudinal apertures 38 having any suitable configuration and spacing may be used to couple the bracket assembly 10 to the longitudinal portion of the fence structure.

Any suitable fastener may be used to couple the bracket inserts 14, 16 to one another including but not limited to dowels, an anti-reverse clip, screws, rivets, snap-fit fasteners, or other similar mechanical fasteners. However, one of skill in the relevant art will understand that the mating surface 26 may include any suitable connection design including but not limited to a snap-fit engagement, pressure fit, or other similar engagement designs. In the embodiment shown in FIGS. 1-7, the bracket inserts 14, 16 are coupled via dowels. In this embodiment, the mating surface 26 of bracket insert 14 includes a plurality of dowel pins 28, and the mating surface 26 of the bracket insert 16 includes a plurality of dowel holes 30. When the two mating surfaces 26 are coupled, the dowel pins 28 are substantially aligned with and inserted into the corresponding dowel holes 30.

In the embodiment shown in FIG. 8, the bracket inserts 14, 16 are coupled via the dowel pins 28 and the dowel holes 30 (not visible on the inner side of bracket insert 14) and a snap-fit coupling. In this embodiment, the snap-fit coupling includes at least one clip extension 48, which is positioned on the bracket insert 16, and at least one groove slot 50, which is positioned on the bracket insert 14, or vice versa. When the two bracket inserts 14, 16 are placed in mating contact with each other, the clip extension 48 is inserted into the groove slot 50 and held in place by a ridge in the groove slot 50 that couples to a lip on the underside of the clip extension 48. In this manner, the clip extension 48 is configured to snap-fit into the substantially aligned groove slot 50 to provide additional connectivity. In the embodiment illustrated in FIG. 8, two clip extensions 48 are configured to couple with two groove slots 50. However, one of skill in the relevant art will understand that any suitable number of clip extensions 48 and groove slots 50, or other suitable snap-fit coupling arrangements or other mechanical or chemical fasteners, may be used to ensure a secure coupling between the bracket inserts 14, 16.

An outer surface 44 of each bracket insert 14, 16 may also include a bracket attachment slot 46. In the embodiment shown in FIGS. 1-7, the bracket attachment slot 46 is configured to create an opening that passes through the body of each bracket insert 14, 16. In the embodiments shown in FIGS. 6 and 7, the bracket attachment slot 46 is shaped to substantially conform to the shape of the insert attachment slot 24. However, any suitable shape for the insert attachment slots 24 may be used that allows a fastening device to pass through the insert attachment slots 24 and the bracket attachment slots 46 to engage the bracket inserts 14, 16 to the bracket 12.

In use, after the bracket inserts 14, 16 have been coupled to one another and have enclosed the portion(s) of the fence structure, the coupled bracket inserts 14, 16 are then coupled to the bracket 12. The bracket inserts 14, 16 are coupled to the bracket 12 by positioning the arms 20 of the bracket 12 adjacent the outer surfaces 44 of the bracket inserts 14, 16 and positioning the insert attachment slot 24 of each arm 20 adjacent the bracket attachment slot 46. A fastening device 56 is then inserted through the insert attachment slots 24 and the bracket attachment slots 46 (as shown in FIG. 7). In this embodiment, the bracket 12 is coupled to the bracket inserts 14, 16 about a single axis formed by the fastening device. Because the bracket attachment slots 46 are shaped to accommodate the cross-sectional shape of the fastening device as well as allowing some additional space surrounding the fastening device, the coupled bracket inserts 14, 16 are able to pivot about the single axis and have the ability to slide a certain distance (defined by the length of the bracket attachment slot 46) in a range of directions relative to the fixed position of the bracket 12. In the embodiments where the insert attachment slot 24 is also shaped to accommodate the cross-sectional shape of the fastening device as well as allowing some additional space surrounding the fastening device, the coupled bracket inserts 14, 16 have the ability to slide a greater distance (defined by the combined length of the bracket attachment slot 46 and the insert attachment slot 24) in a range of directions relative to the fixed position of the bracket 12. As a result, the bracket assembly 10 is coupled to the fence structure and the fence post (or other adjacent structure) in a manner that will accommodate variation in fence post spacing, fence post alignment, and varying terrain.

The foregoing is provided for purposes of illustrating, explaining, and describing embodiments of the present invention. Further modifications and adaptation to these embodiments will be apparent to those skilled in the art. The features and aspects of the present invention have been described or depicted by way of example only and are therefore not intended to be interpreted as required or essential elements of the invention unless otherwise so stated. It should be understood, therefore, that the foregoing relates only to certain exemplary embodiments of the invention, and that numerous changes and additions may be made thereto without departing from the spirit and scope of the invention as defined by any appended claims.

That which is claimed is:

1. A bracket assembly comprising:
(a) a first insert and a second insert, wherein each insert comprises a mating surface;
(b) at least one lateral aperture formed when the mating surface of the first insert and the mating surface of the second insert are coupled to each other, wherein the at least one lateral aperture is configured to at least partially enclose a lateral portion of a fence structure;
(c) a plurality of longitudinal apertures formed when the mating surface of the first insert and the mating surface of the second insert are coupled to each other, wherein the plurality of longitudinal apertures are configured to at least partially enclose a longitudinal portion of the fence structure; and
(d) a bracket configured to couple to the first insert and the second insert.

2. The bracket assembly of claim 1, wherein the first insert and the second insert are releasably coupled to each other and are pivotally coupled to the bracket.

3. The bracket assembly of claim 1, wherein the first insert and the second insert are releasably coupled to each other and are slidingly coupled to the bracket.

4. The bracket assembly of claim 1, wherein the plurality of longitudinal apertures comprise a first longitudinal aperture and a second longitudinal aperture.

5. The bracket assembly of claim 1, wherein the plurality of longitudinal apertures comprise a first longitudinal aperture and a plurality of second longitudinal apertures, wherein the first longitudinal aperture is spaced apart from the plurality of second longitudinal apertures.

6. The bracket assembly of claim 5, wherein the first longitudinal aperture and one of the plurality of second longitudinal apertures are configured to at least partially enclose the longitudinal portion of the fence structure.

7. The bracket assembly of claim 1, wherein the at least one lateral aperture comprises a first lateral aperture and a second lateral aperture.

8. The bracket assembly of claim 1, wherein the first insert and the second insert are releasably coupled to each other via a snap-fit coupling.

9. The bracket assembly of claim 1, wherein the bracket is configured to couple to a fence post.

10. A bracket assembly comprising:
(a) a first insert and a second insert, wherein each insert comprises a mating surface;
(b) at least one lateral aperture formed when the mating surface of the first insert and the mating surface of the second insert are coupled to each other, wherein the at least one lateral aperture is configured to at least partially enclose a lateral portion of a fence structure;
(c) a first longitudinal aperture and a second longitudinal aperture formed when the mating surface of the first insert and the mating surface of the second insert are coupled to each other, wherein the first longitudinal aperture and the second longitudinal aperture are configured to at least partially enclose a longitudinal portion of the fence structure; and
(d) a bracket configured to releasably couple to the first insert and the second insert.

11. The bracket assembly of claim 10, wherein the first insert and the second insert are releasably coupled to each other and are pivotally coupled to the bracket.

12. The bracket assembly of claim 10, wherein the first insert and the second insert are releasably coupled to each other and are slidingly coupled to the bracket.

13. The bracket assembly of claim 10, wherein the at least one lateral aperture comprises a first lateral aperture and a second lateral aperture.

14. The bracket assembly of claim 10, wherein the first insert and the second insert are releasably coupled to each other via a snap-fit coupling.

15. The bracket assembly of claim 10, wherein the bracket is configured to couple to a fence post.

16. A method of assembling a bracket to a fence structure, wherein the bracket comprises
(i) a first insert and a second insert, wherein each insert comprises a mating surface, and (ii) a bracket, the method comprising:
(a) positioning the mating surface of the first insert adjacent the fence structure;
(b) positioning the mating surface of the second insert adjacent an opposing side of the fence structure;
(c) releasably coupling the first insert to the second insert so that the mating surface of the first insert and the mating surface of the second insert form at least one lateral aperture at least partially enclosing a lateral portion of the fence structure, and form a plurality of longitudinal apertures at least partially enclosing a longitudinal portion of the fence structure; and
(d) coupling the first insert and the second insert to the bracket.

17. The method of claim 16, further comprising coupling the bracket to a fence post.

18. The method of claim 16, further comprising rotating the first insert and the second insert relative to the bracket.

19. The method of claim 16, further comprising sliding the first insert and the second insert relative to the bracket.

20. The method of claim 16, wherein the first insert and the second insert are releasably coupled to each other via a snap-fit coupling.
